(19) United States
(12) Patent Application Publication
(10) Pub. No.: US 2009/0244364 A1
(43) Pub. Date: Oct. 1, 2009

(54) MOVING IMAGE SEPARATING APPARATUS, MOVING IMAGE UNITING APPARATUS, AND MOVING IMAGE SEPARATING-UNITING SYSTEM

(75) Inventor: Nobuhiro Nonogaki, Kanagawa-ken (JP)

Correspondence Address: OBLON, SPIVAK, MCCLELLAND MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 12/411,856

(22) Filed: Mar. 26, 2009

(30) Foreign Application Priority Data
Mar. 27, 2008 (JP) 2008-084410

(51) Int. Cl. H04N 7/12; H04N 5/04

(52) U.S. Cl. 348/438.1; 348/501; 348/E05.009; 348/E07.045

(57) ABSTRACT

A moving image separating apparatus is disclosed. The apparatus is provided with a privacy image region detection unit and a moving image separating unit. The privacy image region detection unit detects privacy image region data indicating a position and a range of a privacy image region from the original moving image data. The moving image separating unit receives the original moving image data and the privacy image region data from the privacy image region detection unit. The moving image separating unit separates the original moving image data to private moving image data composed of image data corresponding to the privacy image region and to public moving image data composed of image data of a region excluding the privacy image region, on the basis of the privacy image region data.

### CROSS-REFERENCE TO RELATED APPLICATION

This application is based upon and claims the benefit of priority from the prior Japanese Patent Application No. 2008-84410, filed on Mar. 27, 2008, the entire contents of which are incorporated herein by reference.

### FIELD OF THE INVENTION

The invention relates to a moving image separating apparatus, a moving image uniting apparatus, and a moving image separating-uniting system.

### DESCRIPTION OF THE BACKGROUND

In recent years, a moving picture can be imaged easily with spread of a small-sized moving picture imaging apparatus such as a digital camera or a camera incorporated in a portable terminal. An obtained moving image can be transmitted readily by transmitting a moving image via electronic mail or by up-lording a moving image to a web site. A human image, which should be personal information inherently, is likely to be spread beyond a range intended by a photographer. As a result, likelihood increases to violate privacy of a person who is an object to be imaged.

In Japanese Patent Application publication 2005-109724, pages 4 to 5 and FIG. 1, discloses an imaging apparatus which is capable of protecting the privacy of an object. The imaging apparatus can generate shielding image data corresponding to a shielding region of an object in order that an image of the object is partially shielded and is displayed. The image data of the object and the shielding image data are united so that the shielding image data may be given priority. The united image data is transmitted to an image recording system in association with the information relating to the shielding region.

According to the imaging apparatus, a privacy region of the whole image of the object, which is to be protected, is selected as the shielding region. A privacy mask is inserted as a shielding image in the shielding region. Only the portion where the privacy mask is inserted becomes a black-painted image, for example.

The imaging apparatus needs to unite the image of the object and the shielding image by identifying the privacy mask insertion position by a visual operation and by hand working. The inserting operation takes much time. As the imaging apparatus is small and can not be equipped with a large-sized display unit, it may be difficult to perform an inserting operation of the privacy mask on the display unit.

Once the privacy mask is inserted into the image of the object, its original image, i.e. an original moving image, cannot be recovered. Therefore, when the image of the object including the privacy mask is generated to open the same publicly to a site such as a moving image contribution site, the original image cannot be provided any longer to one, a close relative, for example, to whom disclosure of the privacy should be permitted, even if the original image is intended to be provided after generating the image of the object including the privacy mask.

### SUMMARY OF THE INVENTION

An aspect of the present invention provides a moving image separating apparatus, which includes a privacy image region detection unit to receive original moving image data, the privacy image region detection unit detecting privacy image region data indicating a position and a range of a privacy image region including predetermined privacy information from the original moving image data, and a moving image separating unit to receive the original moving image data and the privacy image region data, the moving image separating unit separating the original moving image data to private moving image data composed of the image data corresponding to the privacy image region and public moving image data of a region excluding the privacy image region, on the basis of the privacy image region data.

An aspect of the present invention provides a moving image uniting apparatus, which includes a moving image uniting unit to receive public moving image data and private moving image data, and a synchronization adjustment unit to receive the public moving image data and the private moving image data, wherein the public moving image data includes first frame data, and the private moving image data includes second frame data, the second frame data being composed of an image of a privacy image region including predetermined privacy information, the first frame data being composed of image data corresponding to a region excluding the privacy image region, the moving image uniting unit unites the public moving image data and the private moving image data to generate original moving image data, and the synchronization adjustment unit controls the moving image uniting unit so as to make synchronization of frames respectively corresponding to the first and second frame data.

An aspect of the present invention provides a moving image separating-uniting system, which includes a moving image separating unit to receive original moving image data and privacy image region data, the privacy image region data being data of the original moving image data to indicate a privacy image region including predetermined privacy information, the moving image separating unit separating the original moving image data to private moving image data composed of the image data of the privacy image region and a public moving image data composed of image data of a region excluding the privacy image region, on the basis of the privacy image region data, a coding unit to execute coding the private moving image data with copy control to generate a first coded stream, the coding unit coding the public moving image data to generate a second coded stream, a decoding unit to execute decoding the first coded stream with copy control to generate decoded private moving image data, the decoding unit decoding the second coded stream to generate decoded public moving image data, and a moving image uniting unit to receive the decoded private moving image data and the decoded public moving image data, the moving image uniting unit replacing a portion of the decoded public moving image data corresponding to the privacy image region with image data of the decoded private moving image data corresponding to the privacy image region, so as to output decoded original moving image data

### BRIEF DESCRIPTION OF THE DRAWINGS

FIG. 1 is a block diagram showing a moving image separating apparatus according to a first embodiment of the invention.

FIG. 2 is a drawing showing an example of an original moving image input to the moving image separating apparatus shown in FIG. 1.

FIG. 3 is a flow chart showing an example of a processing procedure of image data which is performed by the moving image separating apparatus shown in FIG. 1.

FIG. 4 is a drawing to explain a method for detecting a region of eyes of a face.

FIG. 5 is a drawing to explain another method for detecting the region of the eyes of the face.

FIG. 6A is a drawing showing an example of a public moving image.

FIG. 6B is a drawing showing an example of a private moving image corresponding to the public moving image.

FIG. 7 is a block diagram showing a moving image uniting apparatus according to a second embodiment of the invention.

FIG. 8 is a drawing to explain a uniting procedure of images which is performed by the moving image uniting apparatus shown in FIG. 7.

FIG. 9 is a block diagram showing a moving image separating-uniting system according to a third embodiment of the invention.

### DETAILED DESCRIPTION OF THE INVENTION

Hereinafter, embodiments of the invention will be explained with reference to the drawings. In the drawings, the same numerals indicate the same portions respectively.

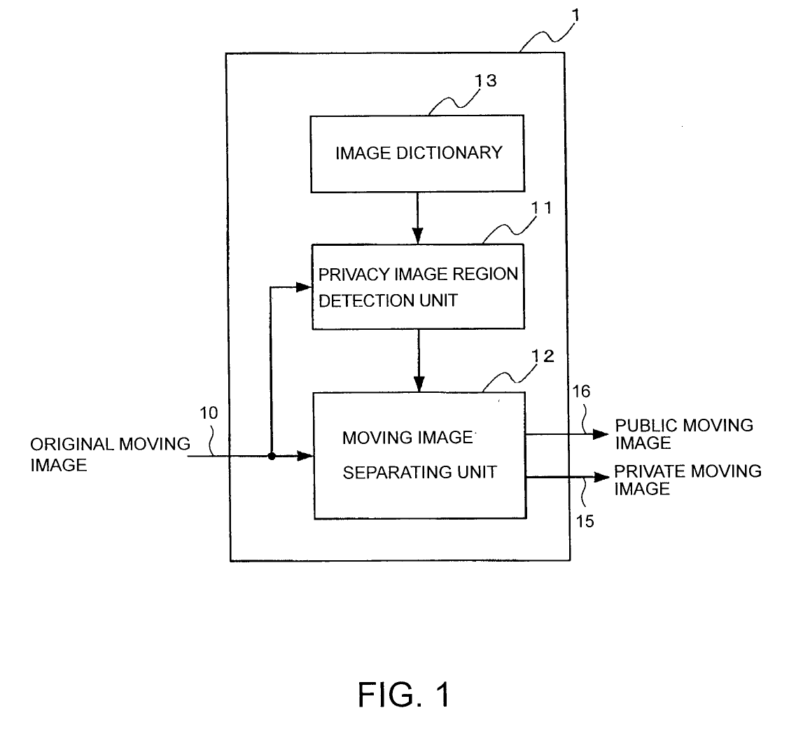

A moving image separating apparatus according to a first embodiment of the invention will be explained with reference to FIG. 1. FIG. 1 is a block diagram showing the moving image separating apparatus according to the first embodiment of the invention.

As shown in FIG. 1, a moving image separating apparatus 1 of the embodiment includes a privacy image region detection unit 11 and a moving image separating unit 12. The privacy image region detection unit 11 detects a region which coincides with a face image pre-stored in an image dictionary 13 to a degree equal to a predetermined threshold value or larger as a privacy image region based on inputted original moving image data 10.

The moving image separating unit 12 separates the original moving image data 10 to private moving image data 15 and public moving image data 16. The private moving image data 15 is composed of image data of the original moving image data 10 corresponding to the privacy image region which is detected by the privacy image region detection unit 11. The public moving image data 16 is composed of image data corresponding to the region excluding the privacy image region.

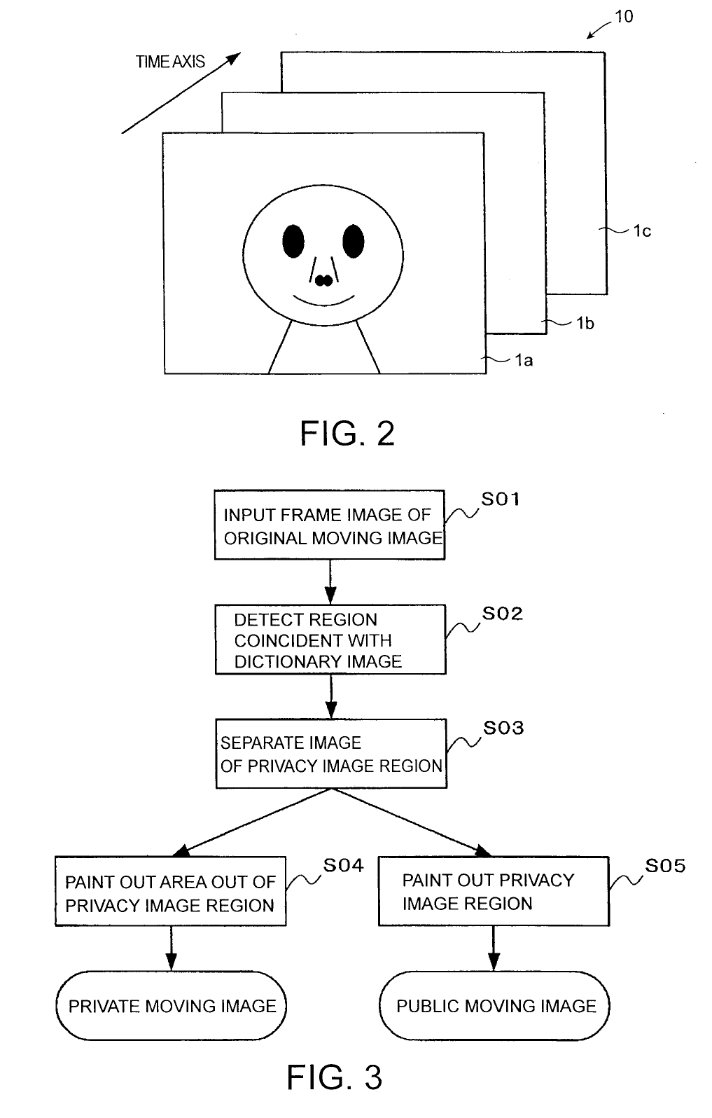

The original moving image data 10, as shown in FIG. 2, is composed of frame image data 1a, 1b, 1c, - - - corresponding to respective frames which are lined up on the time axis.

The privacy image region detection unit 11 compares the original moving image data 10 with the image data pre-stored in the image dictionary 13 frame by frame. By the comparison, the privacy image region detection unit 11 verifies whether information relating to the privacy is included in the original moving image data 10 or not, frame by frame. In the embodiment, the information relating to the privacy is described as a face image, particularly an eye image stored in the image dictionary 13. The privacy image region detection unit 11 verifies whether the face image or the eye image is included in the original moving image data 10 or not, frame by frame.

As a result of the verification, the privacy image region detection unit identifies image region, as the privacy image region data, where the original moving image data and the face image region data coincide with each other to a degree equal to a predetermined threshold value or larger.

The moving image separating unit 12 separates frame image data corresponding to the privacy image region, which are detected by the privacy image region detection unit 11, from the frame image data of the original moving image data 10. The moving image separating unit 12 disposes the separated frame image data on a coordinate position corresponding to a privacy image region of a frame provided separately. In the frame provided separately, the moving image separating unit 12 blacks out the region excluding the image region, on which the privacy image is provided, by reducing signal level of brightness and color difference to zero. The moving image data composed of the frame including the privacy image data becomes the private moving image data 15.

On the other hand, the moving image separating unit 12 blacks out the frame, where the image data corresponding to the privacy image region is removed, by reducing the signal level of brightness and color difference in the privacy image region to zero. The moving image data composed of the frame, where the image corresponding to the privacy image region is removed, becomes the public moving image data 16.

FIG. 3 is a flow chart showing an example of processing procedure of image data by the moving image separating apparatus shown in FIG. 1.

Frame image data of the original moving image 10, which corresponds to a frame, is input to the privacy image region detection unit 12 shown in FIG. 1 (Step S01).

The privacy image region detection unit 11 identifies a region of the input frame image having high coincidence with a face image pre-stored in the image dictionary 13, as a privacy image region (Step S02).

Then, the moving image separating unit 12 separates image data of the frame image data of the original moving image 10 corresponding to the privacy image region. The moving image separating unit 12 gives the image data to a frame provided separately. As a result, the moving image separating unit 12 separates the image data corresponding to the privacy image region from the frame of the original moving image 10 (Step S03).

Furthermore, the moving image separating unit 12 reduces the signal level of brightness and color difference of the region excluding the privacy image region of the frame, where the image corresponding to the privacy image region is provided, to zero. The moving image separating unit 12 blacks out (paints out) the region (Step S04).

The process explained above is performed, frame by frame, for the original moving image 10. As a result, a privacy moving image 15 is formed.

In addition to the aforementioned process, the moving image separating unit 12 reduces signal levels of brightness and color difference of the privacy image region of the frame, where the image in the privacy image region is removed, to zero. Consequently, the moving image separating unit 12 blacks out the privacy image region (Step S05). The blacking-out is equivalent to privacy mask inputting process.

The privacy mask inputting process is performed for each frame of the original moving image so that a public moving image data 16 is generated.

Detection methods for a privacy image region, a region including eyes, for example, which is detected by the privacy image region detection unit 11, will be explained in detail below. The region including the eyes has been recited as the privacy image region, because the eyes and the periphery of the eyes are a region having to do greatly with identification of an individual.

One of the detection methods for the privacy image region includes preparing face image data of an average face image of a predetermined size in the image dictionary and then detecting the face image using the face image data. In the detection method, a region having high coincidence with the average face image is searched from a frame image so that the region including the eyes is inferred.

Another of the detection methods for the privacy image region includes preparing average vector data from a reference point to eye-nose points in the image dictionary and then detecting the privacy image region using the average vector data. In the detection method, candidates of the eye-nose points, which have smallest inner products, are extracted. Eye points are inferred based on the candidates so that the privacy image region is determined.

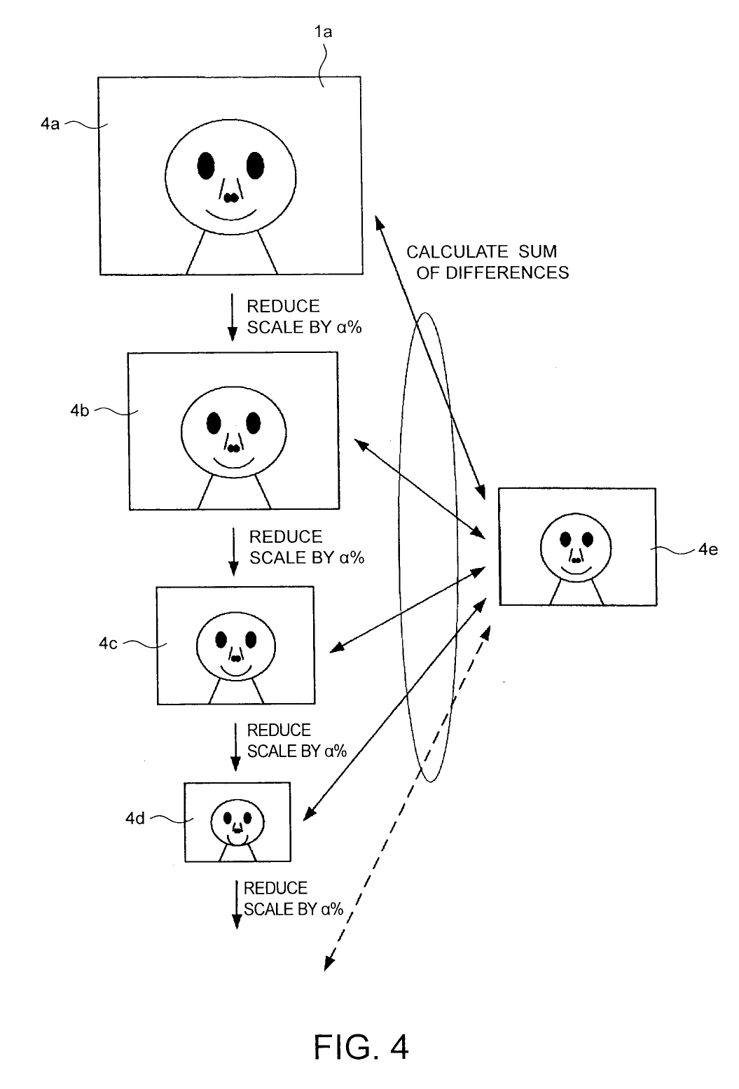

The former detection method will be explained in more detail with reference to FIG. 4. As shown in FIG. 4, the detection method includes calculating sums of differences between the data of a dictionary image 4e and the data of an image 4a, which is the same as the frame image 1a shown in FIG. 2 and the data of a plurality of images 4b, 4c, and 4d which are obtained by reducing the scale of the image 4a by a % step by step. The symbol α indicates a voluntary positive number.

Further, the detection method includes searching for a reduced scale and position of the image, at which one of the sums of the differences are a predetermined threshold value or smaller and are minimum. The sums of the differences are calculated with respect to all of the points of the image 4a, which is the same as the frame image 1a, and the reduced images. As a result of the search, a region of a face image included in the frame image 1a is identified. The detection method extracts a region corresponding to eyes in the face region as a privacy image region, i.e. a region, which is located lower from the top of the face image by 25 to 50% of its height.

The latter detection method may enhance precision of extracting the privacy image region more than the former detection method. The latter detection method stands on the fact that eyes and nostrils have shapes similar to black circles. The latter detection method includes extracting eye-nose point candidates and inferring eye points in light of geometrical position relationship among the eye-nose point candidates so that a privacy image region is determined.

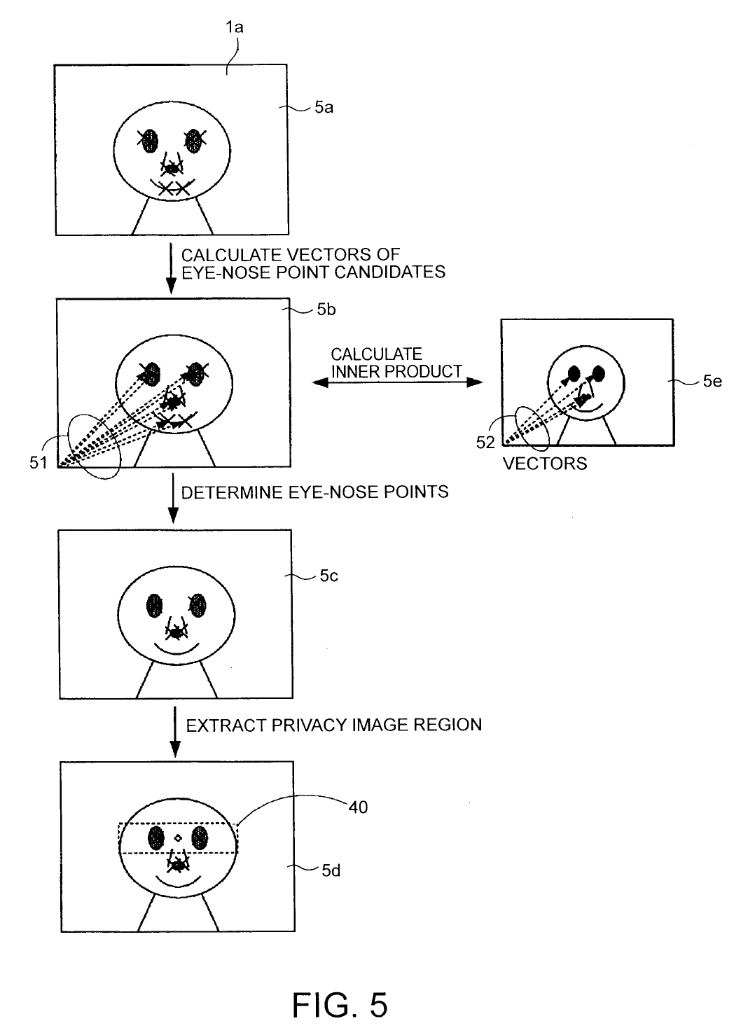

The detection method will be explained in more detail with reference to FIG. 5. In FIG. 5, images 5a to 5e are shown. Data of average vectors extending from a reference point to eye-nose points is stored in the image dictionary 13 shown in FIG. 1.

In FIG. 5, black circular portions is searched in the same image 5a as the frame image 1a, for example. As a result, eye-nose point candidates, which are marks x in FIG. 5, are extracted.

Furthermore, as shown in the image 5b, vectors 51 from the reference point to each eye-nose point (indicated as dotted-line arrows in the image 5b) are calculated. Further, the inner products of the vectors 51 and vectors 52, which are shown in the image 5e and stored in the image dictionary 13, are calculated respectively.

Four points corresponding to the eye-nose point points are identified by finding sets of the vectors 51, 52 which give minimum inner products. Further, positional relationship of the eye-nose points is checked so that the eye-nose points are determined as shown in the image 5c.

Eye points are decided by the determination of the eye-nose points. Then, the position of the center of gravity of both of the eyes is obtained, which is shown as a mark ⋄ in the image 5d of FIG. 5D.

Subsequently, a region around the position of the center of gravity is extracted as a privacy image region 40. In the extraction, the transverse width of the privacy image region 40 may be set to almost the same as the face width. The height of the privacy image region 40 may be set to almost 12.5 to 15% of the transverse width of the privacy image region 40.

As mentioned above, when the privacy image region 40 is extracted, the moving image separating unit 12 shown in FIG. 1 separates the image of the privacy image region 40 from the frame image 1a of the original moving image 10. The separated image of the privacy image region 40 is inserted and included in a frame provided separately. By the insertion, the private moving image 15 is completed. The moving image separating unit 12 generates the public moving image 1, which is composed of a frame image where the image of the privacy image region 40 is separated.

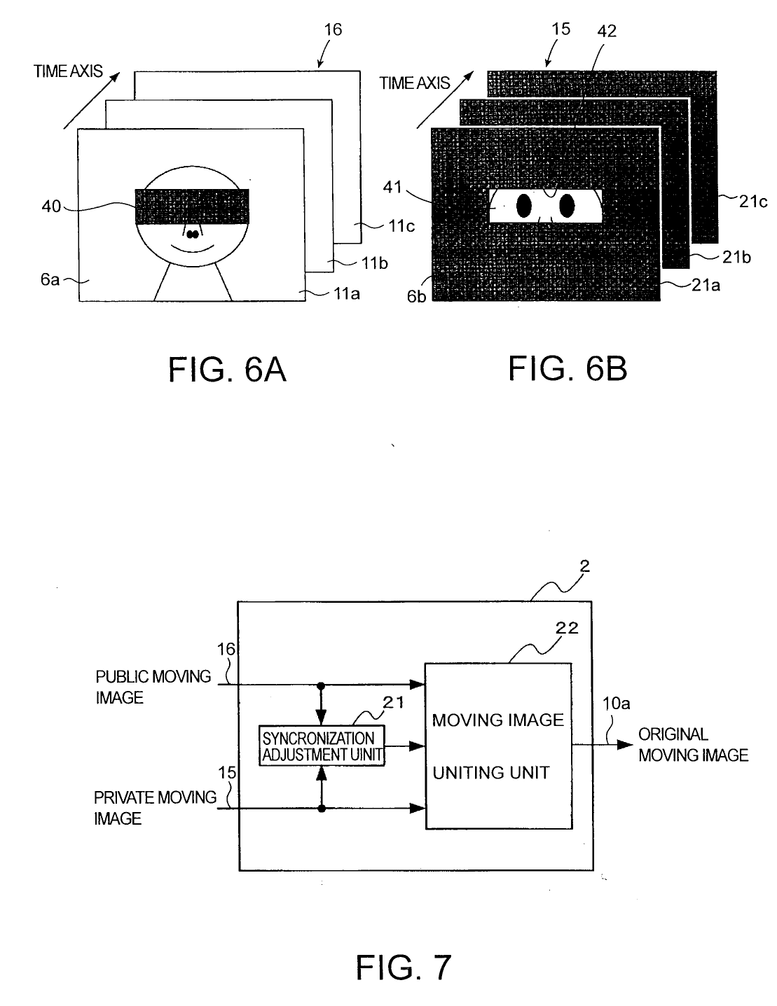

FIGS. 6A and 6B respectively show an example of generating the public moving image data 16 and the private moving image data 15.

As shown in FIG. 6A, the public moving image data 16 is structured in a form that frame images 11a, 11b, 11c, - - - are lined up on the time axis. As mentioned above, the image data of the privacy image region 40 is separated from the frame image data 11a. The privacy image region 40 is blacked out or painted out, by setting the signal level of brightness and color difference to zero.

As shown in FIG. 6B, the private moving image data 15 is structured in a form that frame images 21a, 21b, 21c, - - - are lined up on the time axis. The image data of the privacy image region 40 shown in FIG. 6A is inserted in the frame image data 21a, as image data 41. The frame image data 21a is blacked out or painted out by setting the signal level of brightness and color difference to zero, excluding a privacy image region 42.

According to the embodiment, the prepared data of the image dictionary 13 and the data of the base image 10 are compared so that the privacy image region 40 included in the base image 10 can be extracted automatically. Further, the privacy image region 40 is painted out black so that the public moving image 16 can be generated automatically.

Furthermore, according to the embodiment, the image data 41 of the privacy image region 40 can be separated from the base image 10. The private moving image data 15, which is composed of the frame in which the separated image 41 of the privacy image region 40 is inserted and included into the privacy image region 42, can be generated automatically.

FIG. 7 is a block diagram showing a moving image uniting apparatus according to a second embodiment of the invention.

The embodiment unites the public moving image and the private moving image which is separated by the moving image separating apparatus described in the first embodiment, for each frame, and obtains an original original moving image.

In FIG. 7, the moving image uniting apparatus 2 of the embodiment includes a synchronization adjustment unit 21 and a moving image uniting unit 22. The synchronization adjustment unit 21 detects the timings when the respective frames, which correspond to the inputted public moving image data 16 and the private moving image data 15, shift one after another. The synchronization adjustment unit 21 synchronizes the frame shift timings of the respective frames on the basis of the timing detection. The synchronization adjustment unit 21 permits the frames of the public moving image data 16 and the private moving image data 15 to shift at the same time. The moving image uniting unit 22 unites a frame image of the public moving image data 16 and a frame image of the private moving image data 15 at each synchronization time adjusted.

The signal level of brightness and color difference of the privacy image region is set to zero in the public moving image data 16. The signal level of brightness and color difference of the region excluding the privacy image region 41 is set also to zero in the private moving image data 16. Therefore, when the public moving image data 16 and the private moving image data 15 are united by the moving image uniting unit 22, the output from the moving image uniting unit 22 includes a base image data 10a, which is the same as the original base image data.

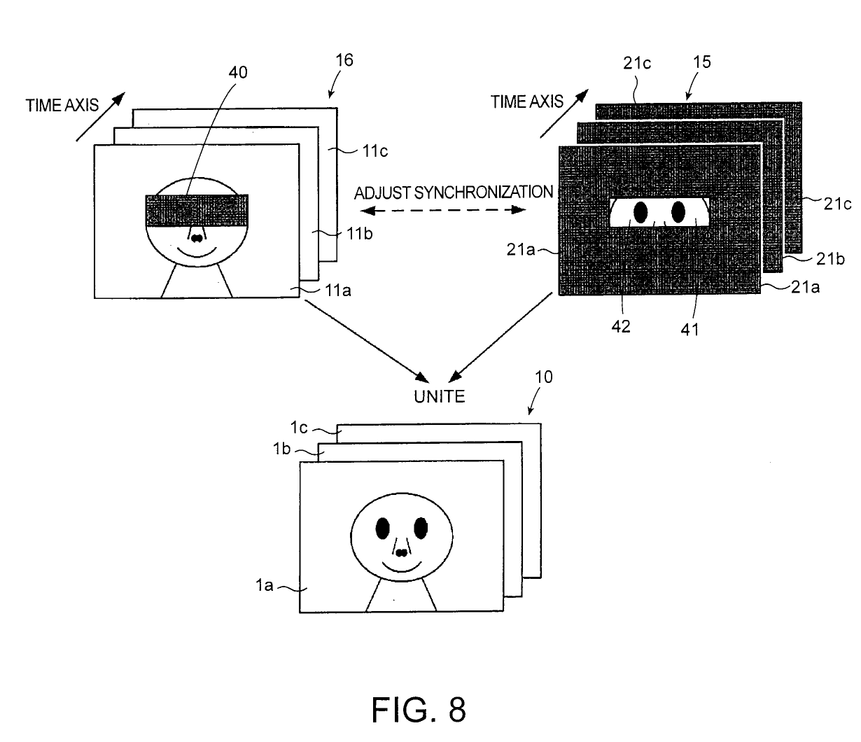

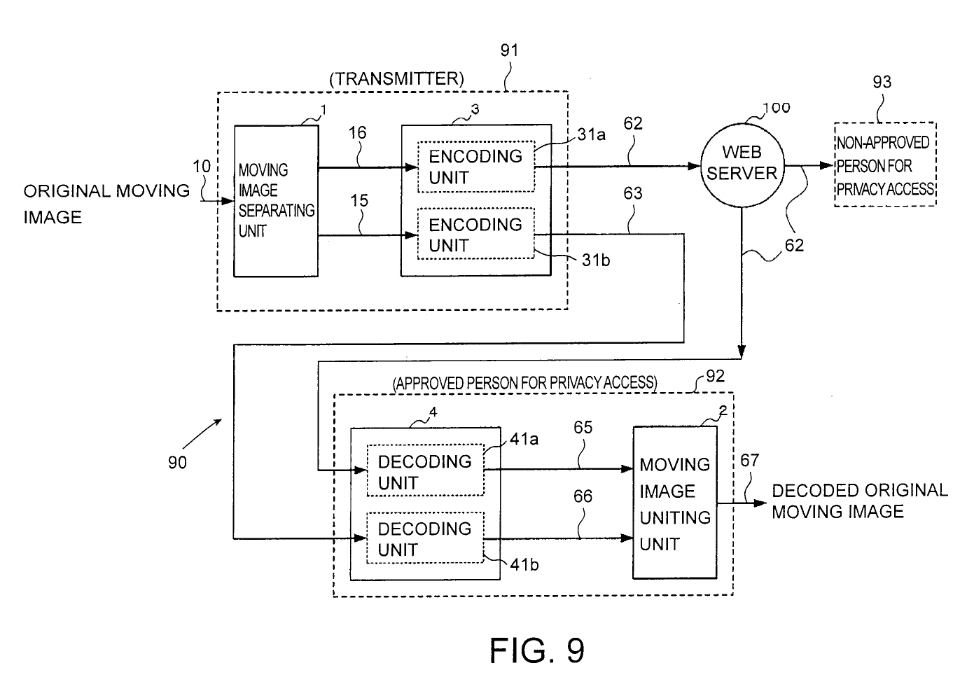

FIG. 8 shows a uniting procedure of picture images using the moving image uniting apparatus according to the embodiment.

As shown in FIG. 8, the public moving image data 16 and the private moving image data 15 are synchronized with each other by the synchronization adjustment unit 21 shown in FIG. 7. As a result, the same frame change timings are obtained for the respective frames of the public moving image data 16 and the private moving image data 15. The black painted region 40 of the frame 11a of the public moving image data 16, which is, in other words, a privacy mask inputted region for the original base image, appears in the frame 21a of the private moving image data 15 at the same time. When the images of the two frames 11a, 21a are united by the moving image uniting unit 22, the frame image corresponding to the original original moving image 10 is obtained.

Such an image combination is executed by replacing the data corresponding to the black painted region 40 with the image data 41 corresponding to the black painted region 42 of the private moving image data 15.

According to the embodiment, even after the privacy mask is inserted in the base image, the original base image can be restored easily.

FIG. 9 is a block diagram showing a moving image separating-uniting system according to a third embodiment of the invention.

In the embodiment, the moving image uniting apparatus 1 of the first embodiment and the moving image uniting apparatus 2 of the second embodiment, which are respectively described above, are used. The embodiment can provide a public moving image data 16 to a non-approved person for privacy access, and can provide the original moving image data 10 to a approved person for privacy access.

A moving image separating-uniting system 90 of the embodiment, as shown in FIG. 9, is provided with a moving image separating apparatus 1, a moving image uniting apparatus 2, a coding unit 3, and a decoding unit 4. The coding unit 3 includes encoding units 31a, 31b. The encoding unit 31b has a copy control function. The decoding unit 4 includes decoding units 41a, 41b. The decoding unit 41b has a copy control function.

The moving image separating apparatus 1 separates the original moving image data 10 to the public moving image data 16 and the private moving image data 15.

The encoding units 31a, 31b encode the public moving image data 16 and the private moving image data 15 separately, which are outputted from the moving image separating apparatus 1. The encoding units 31a, 31b respectively output the encoding results of the inputted moving image data 16, 15, as a coded stream 62 of the public moving image data and a coded stream 63 of the private moving image data.

The decoding units 41a, 41b decode the coded stream 62 of the public moving image data and coded stream 63 of the private moving image data separately, which are outputted from the encoding units 31a, 31b. The coded stream 62 of the public moving image data is opened to the public via a web server 100 and is inputted to the decoding unit 41a.

The decoding units 41a, 41b output the respective decoding results, as decoding public moving image data 65 and decoding private moving image data 66.

The moving image uniting apparatus 2 unites the decoded public moving image data 65 and decoded private moving image data 66, and outputs decoded original moving image data 67.

The moving image separating apparatus 1 and coding unit 3 are arranged on the side of a transmitter 91 of image data and the decoding unit 4. The moving image uniting apparatus 2 are arranged on the side of an approved person 92 for privacy access, i.e. a privacy-opened person who is approved to make access to the privacy by the transmitter 91 of image data.

The moving image separating apparatus 1, as explained in the first embodiment, separates the original moving image data 10, and outputs the public moving image data 16 and private moving image data 15. The public moving image data 16 is a data where the privacy mask is inserted (black painted) in the privacy image region of the inputted original moving image 10. The private moving image data 15 includes the image data corresponding to the privacy image region.

The encoding unit 31b has a function to code the encoding output of the private moving image data 16. The data coded by the encoding unit 31b can not be decoded to the original private moving image data, unless the code canceling key is inputted in the decoding unit 41b having the copy control function,

In the embodiment, the coded stream 62 of the public moving image encoded by the encoding unit 31a is up-loaded to the web server 100. From the web server 100, the coded stream 62 of the public moving image can be down-loaded. By the down-loading, even a non-approved person 93 for privacy access, i.e. a privacy-non-opened person 93 who is approved to make access to the privacy by the image transmitter 91, can see the picture of the public moving image data 16.

On the other hand, the coded stream 63 of the private moving image which is encoded and coded by the coding unit 31b is directly transmitted from the image transmitter 91 to an approved person for privacy access 92. The code canceling key is also transmitted simultaneously to the approved person 92.

The approved person 93 inputs the down-loaded coded stream 62, the coded stream 63 which is directly transmitted from the image transmitter 91, and the code canceling key to the decoding unit 4.

The decoding unit 41a of the decoding unit 4 decodes the coded stream 62 of the public moving image, and outputs the decoded public moving image data 65. The decoding unit 41b decodes the coded stream 63 of the private moving image, while canceling the coded stream 63 using the code canceling key. The decoding unit 41b outputs the decoded decoding private moving image data 66.

The obtained decoded public moving image data 65 and decoded private moving image data 66 are inputted to the moving image uniting apparatus 2.

The moving image uniting apparatus 2, as explained in the second embodiment, unite the images of the respective frames of the inputted decoded public moving image data 65 and the inputted decoded private moving image data 66 to output a decoded original moving image data 67.

Consequently, the approved person 92 may see picture images of the decoded original moving image data 67, by displaying the image of the privacy image region 40 as well as the image of the other region, which are respectively shown in FIG. 8.

According to the embodiment, the non-approved person 93 may decode the coded stream 62 of the public moving image, i.e. the public moving image data, where the privacy mask is inserted. However, the non-approved person 93 can not make access to the privacy image data. Thus, the privacy of the transmitter 91 may protected.

On the other hand, the approved person 92 may decode the coded stream 63 of the private moving image as well as the coded stream 62 of the public moving image. Thus the approved person 92 may obtain the decoded original moving image data 67.

Other embodiments or modifications of the present invention will be apparent to those skilled in the art from consideration of the specification and practice of the invention disclosed herein. It is intended that the specification and example embodiments be considered as exemplary only, with a true scope and spirit of the invention being indicated by the following.

What is claimed is:

1. A moving image separating apparatus, comprising:
a privacy image region detection unit to receive original moving image data, the privacy image region detection unit detecting privacy image region data indicating a position and a range of a privacy image region including predetermined privacy information from the original moving image data, and
a moving image separating unit to receive the original moving image data and the privacy image region data, the moving image separating unit separating the original moving image data to private moving image data composed of the image data corresponding to the privacy image region and public moving image data of a region excluding the privacy image region, on the basis of the privacy image region data.

2. A moving image separating apparatus according to claim 1, further comprising an image dictionary with face image data pre-stored,
wherein the privacy image region detection unit detects image region as the privacy image region data where the original moving image data and the face image region data coincide with each other to a degree equal to a predetermined threshold value or larger.

3. A moving image separating apparatus according to claim 1, wherein the privacy information is image information relating to eyes.

4. A moving image separating apparatus according to claim 1, wherein the privacy image region detection unit calculates the sums of differences between an image data corresponding to the base image data and a plurality of image data obtained by reducing the size of the image step by step and the face image data stored in the image dictionary, the privacy image region detection unit searching for a reduced scale and position of the image at which one of the sums of the calculated differences are smallest value equal to a predetermined threshold value or smaller, the privacy image region detection unit further identifying a face image region included in the moving image on the basis of a result of the search to determine a region corresponding to eyes and to extract the region as the privacy image region data.

5. A moving image separating apparatus according to claim 1, wherein the original moving image data includes face image data and the privacy information is image information relating to eyes.

6. A moving image separating apparatus according to claim 3, wherein the privacy image region detection unit, on the basis of the original moving image data, searches for a plurality of circular portions corresponding to eyes and a nose in the moving image, the privacy image region detection unit identifying an image portion of the eyes among the plurality of circular portions, the privacy image region detection unit further detecting region data including the image portion of the eyes as the privacy image region data.

7. A moving image separating apparatus according to claim 6, further comprising an image dictionary, wherein the image dictionary includes first vector data from a reference point to the eyes and the nose, and the privacy image region detection unit calculates second vector data from the reference point to the plurality of circular portions to calculate inner products of the first and the second vector data, the privacy image region detection unit further identifying the eye-nose positions by finding a set of ones of the first vector data and ones of the second vector data showing minimum inner products.

8. A moving image separating apparatus according to claim 1,
wherein the private moving image data are image data based on the original moving image data which has a region data excluding the privacy image region data, brightness value and color difference value of the region data being substantially zero, and
wherein the public moving image data are image data based on the original moving image data, where brightness value and color difference value of the privacy image region data indicate substantially zero.

9. A moving image uniting apparatus, comprising:
a moving image uniting unit to receive public moving image data and private moving image data; and
a synchronization adjustment unit to receive the public moving image data and the private moving image data, wherein:
the public moving image data includes first frame data, and the private moving image data includes second frame data, the second frame data being composed of an image of a privacy image region including predetermined privacy information, the first frame data being composed of image data corresponding to a region excluding the privacy image region,
the moving image uniting unit unites the public moving image data and the private moving image data to generate original moving image data, and
the synchronization adjustment unit controls the moving image uniting unit so as to make synchronization of frames respectively corresponding to the first and second frame data.

10. A moving image uniting apparatus according to claim 9, wherein the original moving image data includes face image data and the privacy information is image information relating to eyes.

11. A moving image uniting apparatus according to claim 9,
wherein the private moving image data are image data based on the original moving image data which has a region data excluding the privacy image region data, brightness value and color difference value of the region data being substantially zero, and
wherein the public moving image data are image data based on the original moving image data, where brightness value and color difference value of the privacy image region data indicate substantially zero.

12. A moving image separating-uniting system, comprising:
a moving image separating unit to receive original moving image data and privacy image region data, the privacy image region data being data of the original moving image data to indicate a privacy image region including predetermined privacy information, the moving image separating unit separating the original moving image data to private moving image data composed of the image data of the privacy image region and a public moving image data composed of image data of a region excluding the privacy image region, on the basis of the privacy image region data;
a coding unit to execute coding the private moving image data with copy control to generate a first coded stream, the coding unit coding the public moving image data to generate a second coded stream,
a decoding unit to execute decoding the first coded stream with copy control to generate decoded private moving image data, the decoding unit decoding the second coded stream to generate decoded public moving image data, and
a moving image uniting unit to receive the decoded private moving image data and the decoded public moving image data, the moving image uniting unit replacing a portion of the decoded public moving image data corresponding to the privacy image region with image data of the decoded private moving image data corresponding to the privacy image region, so as to output decoded original moving image data.

13. A moving image separating-uniting system according to claim 12, wherein the moving image separating apparatus comprises:
a privacy image region detection unit to receive original moving image data, the privacy image region detection unit detecting privacy image region data from the original moving image data, and
a moving image separating unit to receive the original moving image data and the privacy image region data, the moving image separating unit separating the original moving image data to private moving image data and public moving image data on the basis of the privacy image region data

14. A moving image separating-uniting system according to claim 12,
wherein the coding unit includes a first and a second encoding unit and the decoding unit includes a first and a second decoding unit,
wherein the first encoding unit codes the private moving image data with copy control to generate the first coded stream, and the second encoding unit codes the public moving image data to generate the second coded stream, and
wherein the first decoding unit decodes the first coded stream with copy control to generate the decoded private moving image data, and the second decoding unit decodes the second coded stream to generate the decoding public moving image data.

15. A moving image separating-uniting system according to claim 13, wherein the first decoding unit receives a code canceling key, the first decoding unit decoding the first coded stream while canceling the code using the code canceling key.

16. A moving image separating-uniting system according to claim 13, wherein the second coded stream from the second encoding unit is transmitted to a web server and is opened to the public.

17. A moving image separating-uniting system according to claim 12, wherein the moving image uniting unit includes:
a moving image uniting unit to receive the public moving image data and the private moving image data; and
a synchronization adjustment unit to receive the public moving image data and the private moving image data, and
wherein the moving image uniting unit replacing a portion corresponding to the privacy image region of the decoded public moving image data with image data corresponding to the privacy image region of the decoded private moving image data to produce original moving image data, and
the synchronization adjustment unit controls the moving image uniting unit so as to make synchronization of frames respectively based on frame data of the decoded public moving image data and the decoded private moving image data.

18. A moving image separating-uniting system according to claim 12, wherein the original moving image data includes face image data, and the privacy information is image information relating to eyes.

19. A moving image separating-uniting system according to claim 12, wherein:
wherein the private moving image data are image data based on the original moving image data which has a region data excluding the privacy image region data, brightness value and color difference value of the region data being substantially zero, and
wherein the public moving image data are image data based on the original moving image data, where brightness value and color difference value of the privacy image region data indicate substantially zero.

20. A moving image separating-uniting system according to claim 13, further comprising an image dictionary with data relating to a face image pre-stored, wherein the data of the image dictionary is provided to the privacy image region detection unit to detect the privacy image region.
